(19) United States
(12) Patent Application Publication
(10) Pub. No.: US 2010/0078506 A1
(43) Pub. Date: Apr. 1, 2010

(54) CIRCUMFERENTIAL FUEL CIRCUIT DIVIDER

(75) Inventor: Jason Thurman Stewart, Greer, SC (US)

Correspondence Address: CANTOR COLBURN, LLP, 20 Church Street, 22nd Floor, Hartford, CT, 06103, US

(73) Assignee: General Electric Company, Schenectady, NY (US)

(21) Appl. No.: 12/241,767

(22) Filed: Sep. 30, 2008

(51) Int. Cl. B05B 1/14

(52) U.S. Cl. 239/568; 239/548

(57) ABSTRACT

A fuel nozzle includes a hub with a plurality of output fuel holes arranged perimetrically around the hub. At least two plates located inside the hub define fuel flow passages between an input fuel flow and the output fuel holes. A plurality of enclosures is located between an inner surface of the hub and an outer one of the plates. Each enclosure is in fuel flow communication with first ones of the output fuel holes and the input fuel flow to define a first one of the passages. The two plates define a second one of the fuel flow passages which is in fuel flow communication with the input fuel flow and with second ones of the output fuel holes.

### BACKGROUND OF THE INVENTION

The subject matter disclosed herein relates to turbine engines and, more particularly, to a fuel nozzle having output fuel holes located perimetrically on the hub of the nozzle around its periphery and to an apparatus located on the hub of the nozzle for dividing the input fuel flow between certain ones of the fuel holes.

A swirler-type fuel nozzle may be provided with two separate groups of output fuel holes located on each of the swirler vanes disposed on the hub. The holes within the two groups are typically separated axially from each other on each of the vanes by mechanical fuel routing circuits. The separate hole groupings typically allow for the separate adjustment of the fuel flow as between the resulting two fuel circuits. However, this type of configuration with the holes located on the vanes is relatively costly to manufacture.

### BRIEF DESCRIPTION OF THE INVENTION

According to one aspect of the invention, a fuel nozzle includes a hub with a plurality of output fuel holes arranged perimetrically around the hub. At least two plates located inside the hub define fuel flow passages between an input fuel flow and the output fuel holes. A plurality of enclosures is located between an inner surface of the hub and an outer one of the plates. Each enclosure is in fuel flow communication with first ones of the output fuel holes and the input fuel flow to define a first one of the passages. The two plates define a second one of the fuel flow passages which is in fuel flow communication with the input fuel flow and with second ones of the output fuel holes.

According to another aspect of the invention, a fuel nozzle includes a hub with a plurality of output fuel holes arranged perimetrically around the hub, which is circular in cross section. At least two concentric plates inside the hub and also concentric with the hub define fuel flow passages between an input fuel flow and the output fuel holes, the two plates being circular in cross section. A plurality of enclosures is located between an inner surface of the hub and an outer one of the plates. Each enclosure is in fuel flow communication with first ones of the output fuel holes and the input fuel flow to define a first one of the passages. The two plates define a second one of the fuel flow passages which is in fuel flow communication with the input fuel flow and with second ones of the output fuel holes.

According to yet another aspect of the invention, a fuel nozzle includes a hub with a plurality of output fuel holes arranged perimetrically around the hub, which is circular in cross section. The holes being aligned in a single plane perpendicular to an upstream/downstream axis of the nozzle. At least two plates inside the hub and concentric with the hub define fuel flow passages between an input fuel flow and the output fuel holes, the two plates being circular in cross section. A plurality of enclosures is located between an inner surface of the hub and an outer one of the plates. Each enclosure is in fuel flow communication with first ones of the output fuel holes and the input fuel flow to define a first one of the passages. The two plates define a second one of the fuel flow passages which is in fuel flow communication with the input fuel flow and with second ones of the output fuel holes.

These and other advantages and features will become more apparent from the following description taken in conjunction with the drawings.

### BRIEF DESCRIPTION OF THE DRAWING

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is a perspective view of a fuel nozzle of a turbine engine having a plurality of output fuel holes located perimetrically around a hub;

FIG. 2 is a front perspective view of a portion of an apparatus of an embodiment of the invention for dividing the input fuel flow to the fuel nozzle of FIG. 1 into two separate fuel flows and for providing the separated fuel flows out from certain ones of the fuel holes;

FIG. 3 is a rear perspective view of the portion of the apparatus of FIG. 2;

FIG. 4 is a cutaway view of a further portion of the apparatus of FIGS. 2 and 3 illustrating the two separate fuel flow circuits as passages within the interior of the further portion of the apparatus of FIGS. 2 and 3;

FIG. 5 is a top view of a portion of the apparatus of FIGS. 2-4 illustrating a portion of the two separate fuel flow circuits;

FIG. 6 is a front perspective view, partially cutaway, of a portion of the apparatus of FIGS. 2-4 illustrating the interior fuel flow passages in more detail;

FIG. 7 is a rear perspective view, partially cutaway, of a portion of the apparatus of FIGS. 2-4 illustrating the interior fuel flow passages in more detail;

FIG. 8 is a cutaway view of a portion of the apparatus of FIGS. 2-4 illustrating the flow of fuel through one of the two fuel flow circuits; and

FIG. 9 is a cutaway view of a portion of the apparatus of FIGS. 2-4 illustrating the flow of fuel through another one of the two fuel flow circuits.

The detailed description explains embodiments of the invention, together with advantages and features, by way of example with reference to the drawings.

### DETAILED DESCRIPTION OF THE INVENTION

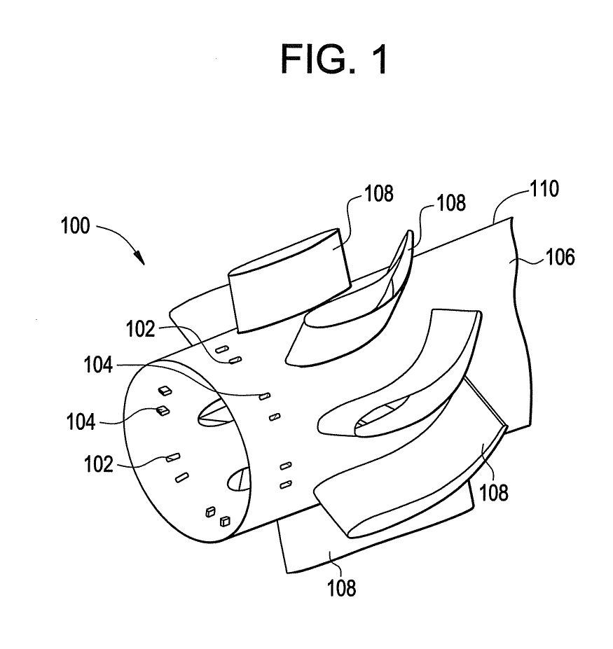

Referring to FIG. 1, a fuel nozzle 100 of a turbine engine includes a plurality of output fuel holes 102, 104 that may be located perimetrically (i.e., on the perimeter) around the periphery of a hub 106 of the fuel nozzle 100. In an embodiment, the hub 106 may be cylindrical in configuration and the holes 102, 104 may be spaced circumferentially around the perimeter of the hub 106 in an alternating, repeating manner. Alternatively, the output fuel holes 102, 104 may be spaced around the hub 106 in a random, non-repeating pattern. The fuel nozzle 100 may be a swirler-type of nozzle having a plurality of swirler vanes 108 located around the outer circumference of the hub 106, for example, at even or uniform spacing between the vanes 108. The fuel holes 102, 104 may be circular, slotted or some other suitable configuration. Also, in an embodiment, the fuel holes 102, 104 may all be aligned in the same axial plane with respect to the upstream/downstream axis of the fuel nozzle 100. The fuel holes 102, 104 each outputs fuel in a known configuration (e.g., a spray configuration) from the upstream side or end of the fuel nozzle 100 where the holes 102, 104 are located further downstream of the fuel nozzle 100 in a known manner. The fuel is provided to the holes 102, 104 through two separate passages or circuits by embodiments of an apparatus 200 according to the invention, as described and illustrated in detail hereinafter.

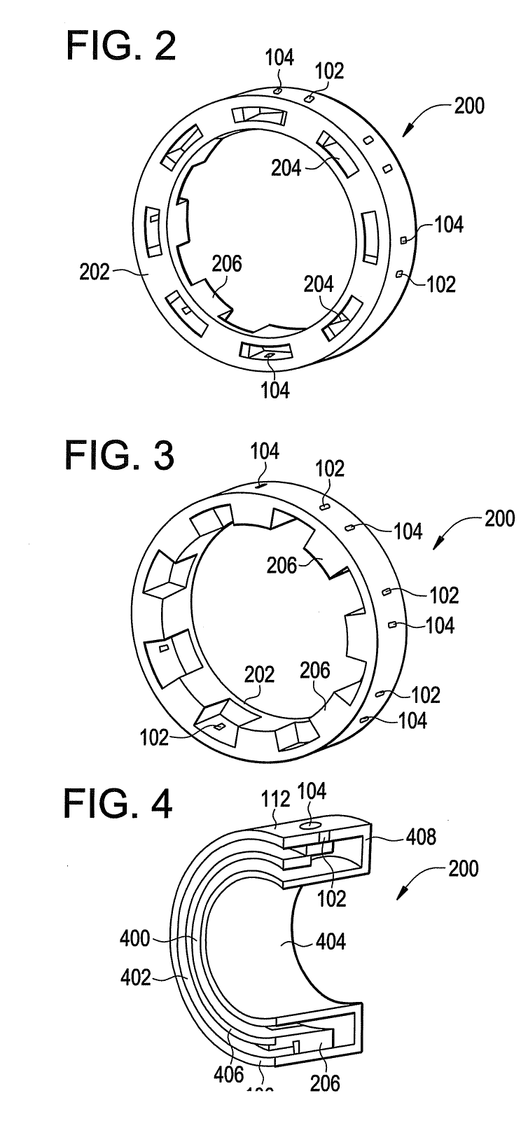

Referring to FIGS. 2 and 3, front (upstream) and rear (downstream) perspective views, respectively, (i.e., opposite views) of a portion of an apparatus 200 divides the input fuel flow to the fuel nozzle 100 of FIG. 1 into two separate and independent fuel flow circuits. These two separate circuits may comprise two separate fuel flow passages or annuli 400, 402 (e.g., an inner passage 400 and an outer passage 402) formed within a further portion of the apparatus 200, as described and illustrated in more detail hereinafter in FIGS. 4-9. The apparatus 200 may be in the shape of a circular ring and formed as an integral part of the hub 106 of the fuel nozzle 100 of FIG. 1. That is, a portion of the outer surface 110 of the hub 106 (i.e., from which the fuel exits the holes 102, 104) may be comprised by an outer surface 112 of the ring 200. The apparatus 200 includes an end plate 202 having a plurality of openings 204, where each opening 204 allows entry of fuel into corresponding enclosures 206 formed in the ring apparatus 200. The openings 204 may be of a slotted configuration or some other suitable configuration. Each enclosure 206 may include at least one output fuel hole 104 within the pair of holes 102, 104 disposed circumferentially around the hub 106. That is, some enclosures 206 may include a single hole 104 while other enclosures 206 may include two or more holes 104, all in a repetitive or non-repetitive pattern.

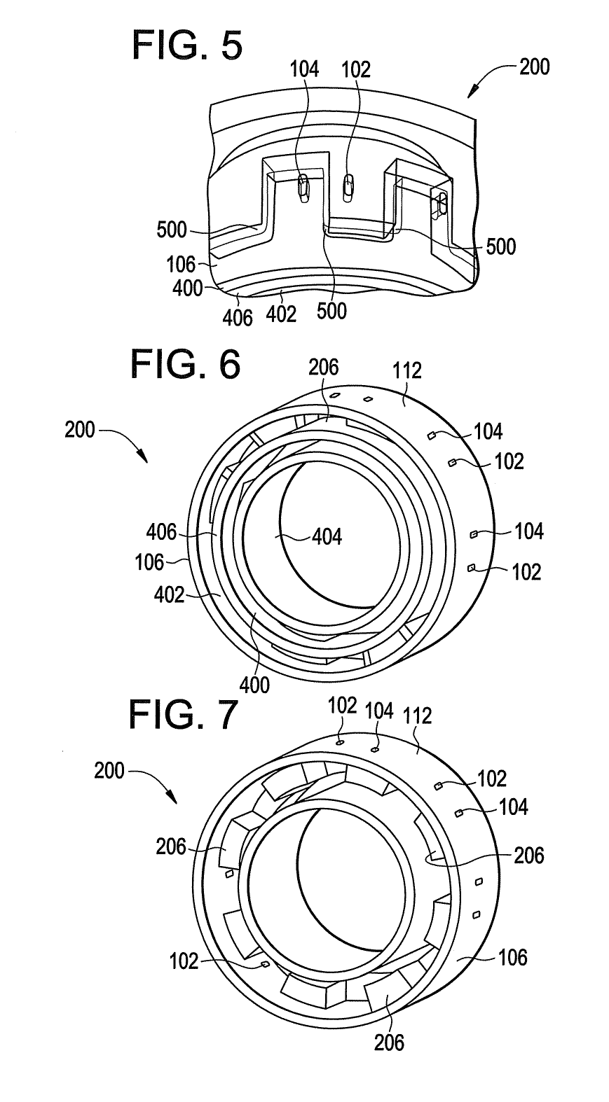

Referring to FIG. 4, a cutaway view of a further portion of the apparatus 200 of FIGS. 2 and 3 illustrates the two separate fuel flow circuits as a pair of passages or annuli 400, 402 located within the interior of the apparatus 200 of FIGS. 2 and 3. In FIG. 4, the upstream side of the apparatus 200 is illustrated on the left hand side and the downstream side of the apparatus is illustrated on the right hand side. Not shown for clarity in FIG. 4 is the end plate 202 with the plurality of slotted openings 204. However, FIG. 4 illustrates some of the enclosures 206 associated with the corresponding fuel hole openings 104. The passages 400, 402 include an outer passage or annulus 402 through which fuel enters from the left hand side in FIG. 4 and an inner passage or annulus 400 also through which fuel enters from the left hand side in FIG. 4. The inner and outer passages 400, 402 are formed by plates 404, 406 that are concentric with each other and with the outer hub 106. The plates 404, 406 may be separate from one another, or may be part of a single component (i.e., cast from one piece of material). The plate 404 terminates at an end opposite to the end with the end plate 202 at another end plate or enclosed surface 408. This surface 408 defines an end point for the passages 400 in an axial direction on the downstream side of the apparatus 200. The plate 406 terminates at an end of each of the enclosures 206, which defines an end point for the passages 402 in an axial direction on the downstream side of the apparatus 200. Alternatively, the plate 406 (and the corresponding passage 402 formed in part thereby) may terminate at the end plate 408. As can be seen in FIG. 4 and in more detail in FIGS. 5-9, the outer passage 402 or annulus comprises a fuel flow circuit that feeds fuel to the holes 104. Further, the inner passage 400 or annulus comprises a fuel flow circuit that feeds fuel to the holes 102.

Referring to FIG. 5, a top view of a portion of the apparatus 200 of FIGS. 2 and 3 illustrates a portion of the two different fuel flow circuits therewithin. FIG. 5 illustrates curved or rounded corner portions 500 of the walls of the enclosures 206. These rounded corner portions 500 help to guide the fuel into the cavity within each of the enclosures 206 to thereby minimize any pressure drop in the fuel. Also illustrated in FIG. 5 are the two input passages or annuli 400, 402 and the concentric plates 404, 406 and the hub 106 that together define the two fuel passages or annuli 400, 402 within the apparatus 200 of an embodiment of the invention.

Referring to FIGS. 6 and 7, front and rear perspective views, respectively, (i.e., opposite views) of a portion of the apparatus 200 of FIGS. 2 and 3 illustrate the fuel flow passages 400, 402 in more detail along with the concentric plates 404, 406 and the hub 106 that together define the two fuel passages or annuli 400, 402. FIG. 6 illustrates the apparatus 200 with the end plate 202 removed for clarity. Also shown in FIGS. 6 and 7 are some of the enclosures 206 and some of the fuel holes 102, 104.

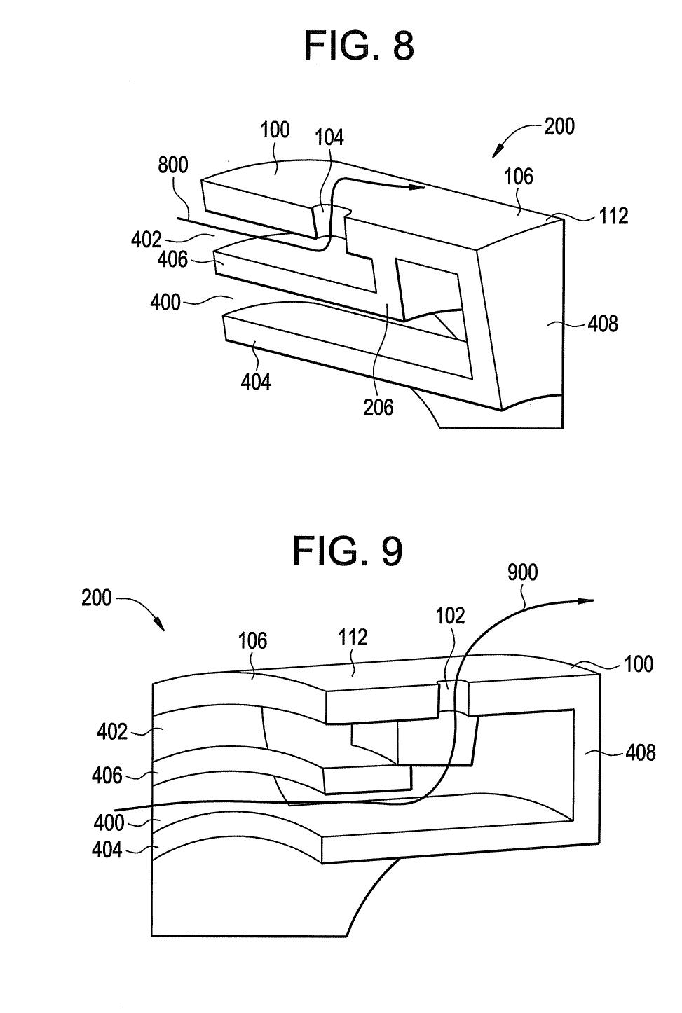

Referring to FIG. 8, a cutaway view of the apparatus of FIGS. 2 and 3 illustrates the flow of fuel (as depicted by the line with the arrowhead 800) through one of the two fuel flow circuits (in this case, the outer fuel flow passage 402 and corresponding enclosure 206), and out through the hole 104 in the hub 106 of the fuel nozzle 100.

Referring to FIG. 9, a cutaway view of the apparatus of FIGS. 2 and 3 illustrates the flow of fuel (as depicted by the line with the arrowhead 900) through another one of the two fuel flow circuits (in this case, the inner fuel flow passage 400), and out through the hole 102 in the hub 106 of the fuel nozzle 100.

By having the two groups or pairs of fuel holes 102, 104 on separate circuits, the fuel flow to one circuit can be increased while the fuel flow to the other circuit can be decreased, thereby allowing the jet penetration to be controlled. Jet penetration is a method to alter the radial fuel profile for the hub hole injection, for example, to increase the jet penetration to make the shroud richer. Also, by having multiple fuel circuits, direct control over the fuel/air profile may be exerted, which may potentially benefit emissions, dynamics and lean blow out.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

1. A fuel nozzle, comprising:
an outer hub having a plurality of output fuel holes passing through the hub, the plurality of output fuel holes being arranged perimetrically around a periphery of the outer hub;
at least two plates located inside of the hub, the at least two plates defining fuel flow passages between an input fuel flow and the plurality of output fuel holes; and
a plurality of enclosures each located between an inner surface of the outer hub and an outer one of the at least two plates, each one of the plurality of enclosures being in fuel flow communication with first ones of the plurality of output fuel holes and being in fuel flow communication with the input fuel flow to thereby define a first one of the fuel flow passages, an inner one of the at least two plates and the outer one of the at least two plates defining a second one of the fuel flow passages which is in fuel flow communication with the input fuel flow and with second ones of the plurality of output fuel holes.

2. The fuel nozzle of claim 1, the at least two plates being concentric with each other and with the hub.

3. The fuel nozzle of claim 1, the hub being circular in cross section, the at least two plates being circular in cross section, the plurality of output fuel holes being disposed circumferentially around a perimeter of the hub, the first ones of the plurality of output fuel holes alternating with the second ones of the plurality of output fuel holes.

4. The fuel nozzle of claim 1, each one of the plurality of output fuel holes being of a circular configuration.

5. The fuel nozzle of claim 1, each one of the plurality of output fuel holes being of a slotted configuration.

6. The fuel nozzle of claim 1, the plurality of output fuel holes being aligned in a single plane perpendicular to an upstream/downstream axis of the fuel nozzle.

7. The fuel nozzle of claim 1, further comprising a plurality of swirler vanes located on an outer surface of the hub.

8. The fuel nozzle of claim 1, further comprising a first end plate located on an upstream side of the hub and having a plurality of openings, each one of the plurality of openings corresponding to one of the plurality of enclosures to allow input fuel to flow into the corresponding one of the plurality of enclosures.

9. The fuel nozzle of claim 1, further comprising a second end plate located on a downstream side of the hub and closing off at least one of the fuel flow passages on the downstream side of the hub.

10. The fuel nozzle of claim 1, each one of the plurality of enclosures having rounded corner portions that guide the input fuel flow into the corresponding one of the plurality of enclosures.

11. A fuel nozzle, comprising:
an outer hub having a plurality of output fuel holes passing through the hub, the plurality of output fuel holes being arranged perimetrically around a periphery of the outer hub, the hub being circular in cross section;
at least two concentric plates located inside the hub, the at least two plates being concentric with the hub and defining fuel flow passages between an input fuel flow and the plurality of output fuel holes, the at least two plates being circular in cross section; and
a plurality of enclosures each located between an inner surface of the outer hub and an outer one of the at least two plates, each one of the plurality of enclosures being in fuel flow communication with first ones of the plurality of output fuel holes and being in fuel flow communication with the input fuel flow to thereby define a first one of the fuel flow passages, an inner one of the at least two plates and the outer one of the at least two plates defining a second one of the fuel flow passages which is in fuel flow communication with the input fuel flow and with second ones of the plurality of output fuel holes.

12. The fuel nozzle of claim 11, each one of the plurality of output fuel holes being of a circular configuration.

13. The fuel nozzle of claim 11, each one of the plurality of output fuel holes being of a slotted configuration.

14. The fuel nozzle of claim 11, the plurality of output fuel holes being aligned in a single plane perpendicular to an upstream/downstream axis of the fuel nozzle, the first ones of the plurality of output fuel holes alternating with the second ones of the plurality of output fuel holes.

15. The fuel nozzle of claim 11, further comprising a plurality of swirler vanes located on an outer surface of the hub.

16. The fuel nozzle of claim 11, further comprising a first end plate located on an upstream side of the hub and having a plurality of openings, each one of the plurality of openings corresponding to one of the plurality of enclosures to allow input fuel to flow into the corresponding one of the plurality of enclosures.

17. The fuel nozzle of claim 11, further comprising a second end plate located on a downstream side of the hub and closing off at least one of the fuel flow passages on the downstream side of the hub.

18. The fuel nozzle of claim 11, each one of the plurality of enclosures having rounded corner portions that guide the input fuel flow into the corresponding one of the plurality of enclosures.

19. A fuel nozzle, comprising:
an outer hub having a plurality of output fuel holes passing through the hub, the plurality of output fuel holes being arranged perimetrically around a periphery of the outer hub, the hub being circular in cross section, the plurality of output fuel holes being aligned in a single plane perpendicular to an upstream/downstream axis of the fuel nozzle;
at least two plates located inside the hub, the at least two plates being concentric with the hub and defining fuel flow passages between an input fuel flow and the plurality of output fuel holes, the at least two plates being circular in cross section; and
a plurality of enclosures each located between an inner surface of the outer hub and an outer one of the at least two plates, each one of the plurality of enclosures being in fuel flow communication with first ones of the plurality of output fuel holes and being in fuel flow communication with the input fuel flow to thereby define a first one of the fuel flow passages, an inner one of the pair of concentric plates and the outer one of the pair of concentric plates defining a second one of the fuel flow passages which is in fuel flow communication with the input fuel flow and with second ones of the plurality of output fuel holes.

20. The fuel nozzle of claim 19, further comprising a first end plate located on an upstream side of the hub and having a plurality of openings, each one of the plurality of openings corresponding to one of the plurality of enclosures to allow input fuel to flow into the corresponding one of the plurality of enclosures, and a second end plate located on a downstream side of the hub and closing off at least one of the fuel flow passages on the downstream side of the hub, the first ones of the plurality of output fuel holes alternating with the second ones of the plurality of output fuel holes.
